(19) United States
(12) Patent Application Publication
(10) Pub. No.: US 2016/0117436 A1
(43) Pub. Date: Apr. 28, 2016

(54) SYSTEM AND METHOD FOR DESIGNING AN INTEGRATED CIRCUIT

(71) Applicant: PLUNIFY PTE LTD, Singapore (SG)

(72) Inventors: Harn Hua NG, Bedok (SG); Kirvy, Wei Sion TEO, Redhill Road #22-82 (SG)

(73) Assignee: PLUNIFY PTE LTD., Ayer Rajah Crescent #03-20/22 (SG)

(21) Appl. No.: 14/898,976

(22) PCT Filed: May 23, 2014
(86) PCT No.: PCT/SG2014/000224

§ 371 Date: Dec. 16, 2015

(30) Foreign Application Priority Data
Jun. 20, 2013 (SG) 201304818-6

(51) Int. Cl. G06F 17/50

(52) U.S. Cl. CPC G06F 17/5081; G06F 17/5045

(57) ABSTRACT

A system and method are provided for compiling an integrated circuit design are described. A web-based client accessible from a personal computer provides access for a user to a network-based server where the user is able to provide an integrated circuit design for compilation. The system propagates values into pertinent parameters for compilation of the circuit design, and further, provides strategies and suggestions based on analysis of past results for propagating values for a plurality of compilation sequences. Compilation of the integrated circuit design is carried out on server-based computing resources by way of parallel compilation of the plurality of compilation sequences, allowing for concurrent time-saving operation.

### TECHNICAL FIELD

The present disclosure relates generally to a system and method for designing an integrated circuit. In particular, a system and method are provided for compiling an integrated circuit design.

### BACKGROUND

Chip design is an iterative process whereby engineers spend much time crafting and running experiments with different input parameters, in attempts to achieve target metrics like frequency, power and/or area. The ever-increasing complexities of chip design require more and more time and computing power to be spent on these experiments. Engineering methodologies have not evolved together with the complexities, such that typically, these experiments are conducted and analyzed serially instead of in parallel. In addition, the development of efficient and effective chip design experiments usually requires years of experience from individual engineering teams or personnel, and there is a lack of continuity and collaboration among separate teams or companies.

A chip design compiler has many options (“tool options”) that end-users can specify. Such options affect the results of compilation, meaning the outcome of whether or not a given chip design meets intended design metrics or objectives. Each processing task (each “compilation”) generates outputs that the end-user must study in order to determine how to change the design, the design constraints and/or the tool options in order to meet the design objectives.

Compilation is a time- and computational resource-consuming process, often requiring end-users to use dedicated computing servers. A limited number of software compiler licenses also restricts end-users to running one or a small number of compilations at the same time, making the chip design process undesirably iterative from the perspective of the end-user, and lengthy in nature.

More importantly, current design methodologies do not lend themselves well to managing multiple compilations. Each compilation generates amounts of data that are essentially impossible to examine and keep track of by hand. Typically, end-users have to manually compare and analyze the compilation outputs across multiple compilations if they do it in the first place. In addition, current software tools do not adequately aid users in effectively analyzing or understanding the compilation outputs, such that the end-user can identify and implement subsequent design changes in a shorter amount of time. A need exists for a system and method for compiling an integrated circuit design that overcomes such limitations.

### SUMMARY

According to an aspect of the present disclosure, there is provided a method for designing an integrated circuit, including: accessing a circuit design and identifying a plurality of parameters related to an achieved efficiency of the circuit design; propagating values into the plurality of parameters to obtain a compilation sequence for compiling the circuit design, further including obtaining a plurality of compilation sequences; providing the circuit design and the plurality of compilation sequences as input to a compilation execution module for compiling the circuit design based on the plurality of compilation sequences on an array of computing modules; obtaining an output score for each of the plurality of compiled compilation sequences in validating the integrated circuit design; and identifying the occurrence of output scores meeting a predetermined performance target, and if none, propagating values into the plurality of parameters to obtain a further plurality of compilation sequences for compiling at the compilation execution module; wherein the compiling of the plurality of compilation sequences is carried out in parallel.

In an embodiment, the method further includes collating the output score together with the compilation sequence input for each of the plurality of compiled compilation sequences for storing in a database; and correlating output scores with the values of the plurality of parameters for each of the plurality of the compiled compilation sequences in determining a relevancy for each of the plurality of parameters in relation to the achieved efficiency.

In an embodiment, the method further includes utilizing the relevancy for each of the plurality of parameters in propagating values into the plurality of parameters to obtain a further plurality of compilation sequences for compiling at the compilation execution module.

In an embodiment, the parameters with a higher relevancy are propagated first in obtaining a compilation sequence.

In an embodiment, each of the plurality of compilation sequences is unique with respect to the plurality of parameters.

In an embodiment, the relevancy is determined by any one of a statistical weight, heuristics, and a machine learning algorithm.

In an embodiment, the method further includes analyzing compiler output files for a compiled compilation sequence, and identifying any one of: compilation timings for a plurality of sub-processes during compiling, timing results factors, software runtime for compilation steps, and power estimate types.

In an embodiment, the compilation timings are correlated to determine a sub-process for which design changes have statistically the greatest effect on the compilation timings.

In an embodiment, the sub-process includes one of a list of: initial placement for architecture specific features, global placement, placement optimization, global clock region assessment, local placement optimization, and design feasibility check.

In an embodiment, propagating values into the plurality of parameters to obtain a compilation sequence for compiling of the circuit design further includes: accessing a database and, based on the circuit design, determining a relevancy for each of the plurality of parameters in relation the achieved efficiency; and utilizing the relevancy for each of the plurality of parameters in propagating values into the plurality of parameters to obtain a compilation sequence.

In an embodiment, the array of computing modules comprises any one of an array of hardware servers, an online cloud computing resource, and a combination of an array of hardware servers and an online cloud computing resource.

In an embodiment, the method further includes determining the computing resource to be used and committing the computing resource in compiling the circuit design based on the plurality of compilation sequences.

In an embodiment, the method further includes providing a web-based user interface for receiving a circuit design from a user, the web-based user interface coupled to a central processing module hosted on a server.

In an embodiment, the method further includes determining committed computing resources for compiling the circuit design and distributing the plurality of compilation sequences for carrying out in parallel amongst the committed computing resources with the central processing module.

In an embodiment, the plurality of compilation sequences number greater than the committed computing resources, further comprising placing excess compilation sequences in queue for consecutive operation.

In an embodiment, the method further includes providing the compilation results, comprising at least the output score, to the user through the web-based interface.

In an embodiment, the method further includes encrypting the compilation results prior to providing them to the user.

In an embodiment, errors in the compilation results are highlighted, and suggestions for improvement are presented within the compilation results to the user.

In an embodiment, the suggestions for improvements comprise at least an analysis of the compilation timings and a relevancy of each of the plurality of parameters with respect to the circuit design.

In an embodiment, the plurality of parameters comprise any one of a synthesis option, a floor-planning option, a place and route option, a timing constraint, an area constraint, and a location constraint.

In an embodiment, the output score comprise any one of a timing score, an area utilization and an estimated power.

According to a next aspect of the present disclosure, there is provided a system for designing an integrated circuit, comprising: an input analysis module for accessing a circuit design and identifying a plurality of parameters related to an achieved efficiency of the circuit design; a compilation build module for propagating values into the plurality of parameters to obtain a compilation sequence for compiling the circuit design, further for obtaining a plurality of compilation sequences; a compilation execution module for: receiving the providing the circuit design and the plurality of compilation sequences; compiling the circuit design based on the plurality of compilation sequences on an array of computing modules; and obtaining an output score for each of the plurality of compiled compilation sequences in validating the integrated circuit design; and a compilation analysis module for identifying the occurrence of output scores meeting a predetermined performance target, and if none, instructing the compilation build module to propagate values into the plurality of parameters to obtain a further plurality of compilation sequences for compiling at the compilation execution module; wherein the compiling of the plurality of compilation sequences is carried out in parallel.

In an embodiment, the compilation analysis module is further for: collating the output score together with the compilation sequence input for each of the plurality of compiled compilation sequences for storing in a database; and correlating output scores with the values of the plurality of parameters for each of the plurality of the compiled compilation sequences in determining a relevancy for each of the plurality of parameters in relation to the achieved efficiency.

In an embodiment, the compilation build module further utilizes the relevancy for each of the plurality of parameters in propagating values into the plurality of parameters to obtain a further plurality of compilation sequences for compiling at the compilation execution module.

In an embodiment, the parameters with a higher relevancy are propagated first in obtaining a compilation sequence.

In an embodiment, each of the plurality of compilation sequences is unique with respect to the plurality of parameters.

In an embodiment, the relevancy is determined by any one of a statistical weight, heuristics, and a machine learning algorithm.

In an embodiment, the compilation analysis module is further for analyzing compiler output files for a compiled compilation sequence, and identifying any one of a compilation timings for a plurality of sub-processes during compiling, timing results factors, software runtime for compilation steps, and power estimate types.

In an embodiment, the compilation timings are correlated to determine a sub-process for which design changes have statistically the greatest effect on the compilation timings.

In an embodiment, the sub-process includes at least one of: initial placement for architecture specific features, global placement, placement optimization, global clock region assessment, local placement optimization, and design feasibility check.

In an embodiment, the compilation analysis module is further for: accessing a database and, based on the circuit design, determining a relevancy for each of the plurality of parameters in relation the achieved efficiency; and utilizing the relevancy for each of the plurality of parameters in propagating values into the plurality of parameters to obtain a compilation sequence.

In an embodiment, the array of computing modules comprises any one of an array of hardware servers, an online cloud computing resource, and a combination of an array of hardware servers and an online cloud computing resource.

In an embodiment, the system further includes a computing resource management module for determining the computing resource to be used and committing the computing resource in compiling the circuit design based on the plurality of compilation sequences.

In an embodiment, the computing resource management module distributes the plurality of compilation sequences for carrying out in parallel amongst the committed computing resources.

In an embodiment, the plurality of compilation sequences number greater than the committed computing resources, and the computing resource management module places excess compilation sequences in queue for consecutive operation.

In an embodiment, the system further includes a web-based user interface for receiving a circuit design from a user, the web-based user interface coupled to a central processing module hosted on a server.

In an embodiment, the compilation results, comprising at least the output score, are provided to the user through the web-based interface.

In an embodiment, the system further includes a client-server communications module for encrypting the compilation results prior to providing them to the user.

In an embodiment, the errors in the compilation results are highlighted, and suggestions for improvement are presented within the compilation results to the user.

In an embodiment, the suggestions for improvements comprise at least an analysis of the compilation timings and a relevancy of each of the plurality of parameters with respect to the circuit design.

In an embodiment, the plurality of parameters comprise any one of a synthesis option, a floor-planning option, a place and route option, a timing constraint, an area constraint, and a location constraint.

In an embodiment, the output score comprise any one of a timing score, an area utilization and an estimated power.

### BRIEF DESCRIPTION OF DRAWINGS

Embodiments of the present disclosure are explained, by way of example, and with reference to the accompanying drawings. It is to be noted that the appended drawings illustrate only examples of embodiments of this disclosure and are therefore not to be considered limiting of its scope, for the disclosure may admit to other equally effective embodiments.

FIG. 1 illustrates a system for designing an integrated circuit according to an embodiment.

FIG. 2 illustrates a schematic representation of program instruction sets corresponding to the system of the present embodiment.

FIG. 3 illustrates a flow diagram of a method for designing an integrated circuit according to an aspect of the present disclosure.

FIG. 4 illustrates design data which is extracted by the system according to an embodiment.

FIG. 5 illustrates a resultant compilation output timing chart after carrying out compilation runs according to the present embodiment.

FIG. 6 illustrates a resultant compilation output software runtime chart after carrying out compilation runs according to the present embodiment.

FIG. 7 illustrates a resultant compilation output power estimate chart after carrying out compilation runs according to the present embodiment.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure.

Furthermore, in various embodiments the disclosure provides numerous advantages over the prior art. However, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, any reference to “the invention” shall not be construed as a generalization of any inventive subject matter disclosed herein and shall not be considered to be an element or limitation of the appended claims except where explicitly recited in a claim(s).

In the present disclosure, depiction of a given element or consideration or use of a particular element number in a particular FIG. or a reference thereto in corresponding descriptive material can encompass the same, an equivalent, or an analogous element or element number identified in another FIG. or descriptive material associated therewith. The use of “/” herein means “and/or” unless specifically indicated otherwise.

As used herein, the term “set” corresponds to or is defined as a non-empty finite organization of elements that mathematically exhibits a cardinality of at least 1 (i.e., a set as defined herein can correspond to a singlet or single element set, or a multiple element set), in accordance with known mathematical definitions (for instance, in a manner corresponding to that described in An Introduction to Mathematical Reasoning: Numbers, Sets, and Functions, “Chapter 11: Properties of Finite Sets” (e.g., as indicated on p. 140), by Peter J. Eccles, Cambridge University Press (1998)). In general, an element of a set can include or be a system, an apparatus, a device, a structure, a structural feature, an object, a process, a physical parameter, or a value depending upon the type of set under consideration.

The terms “group” and “gang” as used herein correspond to or are defined as an organization of two or more elements, e.g., a group or gang can be defined as a set having at least two components. The term “subgroup” as used herein corresponds to or is defined as a portion of a group or gang, and hence corresponds to or can be defined as an organization of at least one element, e.g., a subgroup can be defined as a set having at least one component.

Embodiments in accordance with the present disclosure are directed to systems and methods for designing an integrated circuit. In particular, present embodiments are directed to system and methods compiling an integrated circuit design, in which a user provides a circuit design to a server-based system capable of executing a plurality of compilations of the provided circuit design.

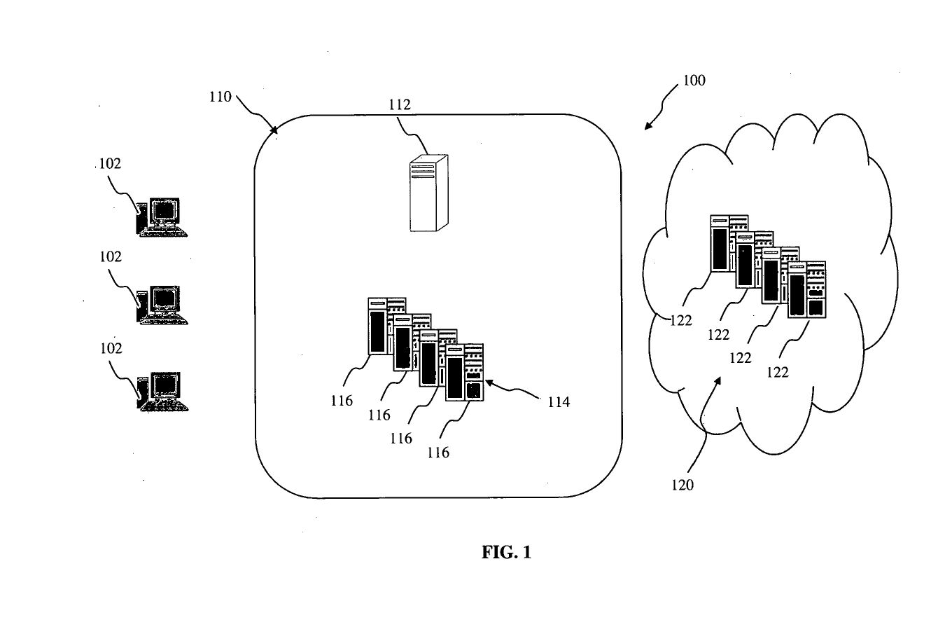

According to an embodiment of the present disclosure, there is provided a system for designing an integrated circuit, in particular, for compiling a design of an integrated circuit. FIG. 1 illustrates a system for designing an integrated circuit according to an embodiment. According to an embodiment system 100 includes a centrally-hosted server 110 operated by a computing system 112 including at least one processor, a memory, and a communications portal. In the present disclosure, mention of a processor, a memory and a communications portal are not limiting, nor intended to be limiting. For example, a processor includes a semiconductor chip configured to operate an operating system hosted in the memory, the memory for storing and hosting a plurality of instructions that when executed by the processor, carry out the instructions to achieve various functions. Further, memory as presented may also include data storage elements or a flash memory, or any other form of recordable medium.

The central server 110 undertakes multiple client relationships with remotely located computing devices 102, such as personal computers (PCs), corresponding to users, each with access to a network such as the Internet. Users are able to gain access through a web-based interface, a graphical user interface, or a command-line interface to the capabilities of the central server 110 and the system 100 according to the present disclosure, provided as a service offering. Data communication is provided two-way, between the multiple users each on their individual PCs 102 and the central server 110. Further, it is of note that there needs to be no permanent relationship according to the system and method of the present disclosure between a user and a PC 102 for communication with the central server 110. Web-based, graphical, and/or command-line-based access is possible, thereby not limiting a user to a particular physical PC, for example, having installed proprietary software with a purchased license key. A user may obtain access to the central server 110 and the service offerings from any computer with Internet access, preferably undertaking an authentication procedure as provided by the present system 100 below.

The computing system 112 includes coupling to a local server infrastructure 114 including a plurality of server modules 116. The local server infrastructure 114 and plurality of server modules 116 provide the central server 110 with expanded computing resources for compiling of a circuit design according to the present disclosure. The server infrastructure 114 and plurality of server modules 116 are provided as local to the central server 110 and is provisioned to operate as application servers, dedicated to operate based on instructions from the central server 110.

Further, in the present embodiment, the system 100 includes a cloud-based server infrastructure 120, including a plurality of server modules 122 which may or may not be provided together at a particular physical location. The cloud-based server infrastructure 120 is coupled over an internet protocol network and provides additional computing resources for the central server 110 to utilize in compiling the provided circuit design. The cloud-based server infrastructure 120 is typically operated by a third-party provider, and access to the cloud-based server infrastructure 120 is through a subscriber service. The cloud-based server infrastructure 120 may also be operated by local resources. The cloud-based server infrastructure 120 may include a fixed number of server modules 122 or a varying number of server modules 122 depending on demand for or need of computing resources, where the number of server modules 122 provided to the cloud-based server infrastructure 120 can be dependent on the terms of the provider service.

In the present embodiment, the system 100 includes computing resources which are provided by a local server infrastructure 114 and a cloud-based server infrastructure 120. In other embodiments, the computing resources operated by the central server in the system according to the present disclosure may be provided solely by physically coupled local server infrastructure 114 with a plurality of server modules 122. Having only local server infrastructure 114 can provide an advantage where the server resources are dedicated for the system's usage in designing an integrated circuit. However, costs may be dramatically increased for acquisition as well as maintenance of the physical server modules 122. Alternatively, the computing resources may be solely provided by a cloud-based server infrastructure 120, where the computer resources are scalable in accordance to present demand/need. Such an arrangement provides a fully scalable option wherein computing resources may have essentially no limit with respect to the amount of resources required by the central server 110. Some disadvantages may be uncertainties such as and not limited to, for example network connectivity, power stability, data communications linkage, security, in carrying out secure computing operations apart from local computing systems. Finally, the computing resources may be provided by a hybrid of local and cloud-based server infrastructure.

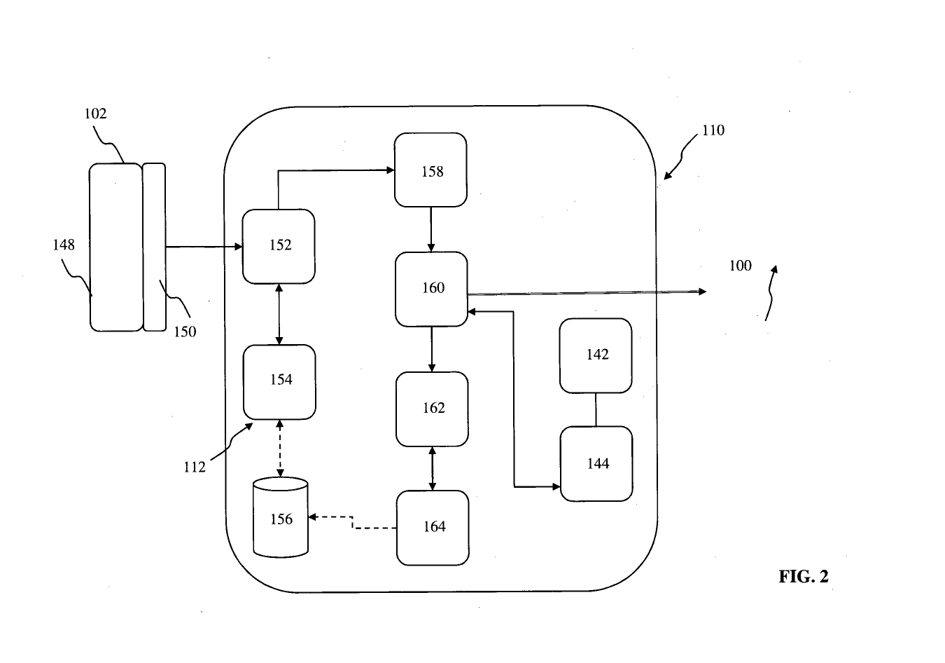

In the present embodiment, a server access module 142 is provided in the system 100 for access to the cloud-based server infrastructure 120. Such a feature is shown in FIG. 2, which illustrates a schematic representation of program instruction sets corresponding to the system of the present embodiment. The system 100, in particular the computing system 112, includes a server access module 142 that is provided with internet protocol-based network access, preferably through a hardwire communications link coupled to the computing system 112. The server access module 142 is intended to communicate with and link to the cloud-based server infrastructure 120, and through the cloud-based infrastructure 120, to other coupleable or provided cloud based server modules 122. As mentioned above, the cloud-based server infrastructure 120 is typically operated by a third party provider. The server access module 142 thus carries out communication and authentication with an authentication module provided on the cloud-based server infrastructure 120. Should a communications link be required and initiated by the server access module 142, the server access module further upholds the data communications link until completion of program execution by the cloud-based server modules 122. In the present disclosure, with regard to the term “module”, it is stated that the term refers to the particular function or functions performed by the associated processing unit, such as by way of execution of program instruction sets; the “module” may or may not correspond to actual electrical circuitry. In the present embodiment, multiple modules are operated as part of instructions carried out by the processor of the central server 112, although in other embodiments, this may not necessarily be so.

System 100 further includes a computing resource management module 144 which supervises computing resources made available on local server infrastructure 114 as well as cloud-based server infrastructure 120. The computing resource management module 144 further translates and relays instructions provided by the central server 112 for control of computing resources. The computing resource management module 144 supervises, controls, monitors and tracks execution of instructions provided by the central server 112 to the local and/or cloud-based server infrastructure 114, 120. In a further function, the computing resource management module 144 initiates a request with the local or third-party provider provisioning server modules 122 for the cloud-based infrastructure 120 for additional server modules 122 to support an increase in computing resources, in the event that a surge of end-user requests for circuit design capabilities from the system 100 of the present disclosure occurs. The computing resource management module 114 petitions and obtains additional computing resources and distributes the computing resources in accordance to instructions from the central server 112.

Further operational processes of the central server 110 will be discussed later, together with the description of a method according to the present disclosure. Further features of the present system 100 are presently discussed. In user PC 102 of the present embodiment, web-based access is provided to the services of the system 100. A web application 148, in the present embodiment is an internet browser-based portal, including web pages written in HyperText Markup Language, and provides user operability for features provided by the present system 100. In other embodiments, the web application is a command-line scripting Application Programming Interface (API) or a compilation software graphical user interface (GUI). Access to the web application 148 on the user's PC 102 is user specific and access may be authenticated by various authentication methodologies. For example, asymmetric key cryptography for user authentication is carried out with the user's PC, in conjunction with a regular user-name and password check, to allow access to the web application 148 through a secure socket layer (SSL).

With and through the web application 148, a user is able to carry out multiple options in relation to the services provided by the system 100, in particular that of compilation of a proposed integrated circuit or chip design. Through the web application 148, a user is able to submit or upload his chip design. Typically, the user is an integrated circuit designer who runs on his PC one of a myriad of chip design tools, for example Mentor Graphics ModelSim, Synopsys Synplify, Xilinx ISE, Xilinx Vivado, Microsemi Libero and Altera Quartus, amongst various others, in coming up with a preliminary chip design. With the newly designed integrated circuit, a user can simply open up a web browser and switch over to the web application 148 in accessing the system's 100 offering(s). Thereafter, the new chip design is provided to the system 100 of the present disclosure for compiling and verification of the new chip design.

Further, the web application 148 can display results, analysis, feedback, errors, warnings, and any other relevant information in reviewing a compilation exercise for the submitted chip design. Other functions of the web application 148 are also possible, bearing in mind the main role of the web application 148 is providing communication access to the system 100 of the present disclosure.

In addition, the user PC 102 includes a client module 150. Such a module is typically software based, written into local memory of the user PC 102 and carried out or executed by the processor of the user PC 102. The client module 150 carries out secure communication between the user PC 102 and the central server 110, and thereafter receives input and provides output for display corresponding to user interaction with the GUI 148. Several pertinent functions of the client module 150 include, for example, and are not limited to, the storage and handling of authentication key-pair between the server 110 and client 150; carrying out data encryption of information sent from the client module 150 to the server 110, e.g. submitted chip designs for compilation; distributed, encrypted uploads; receiving result summaries; parsing for display output data analysis; and decrypting received information from the server 110.

Central server 110 includes a client-server communications module 152, for transmitting and receiving information between the user PC 102 and the central server 110, more particularly between the client module 150 and the central server 110. The client-server communications module 152 is configured for communication between a plurality of client modules 150 and the central server, and also provides a plurality of data communications, transmission, and reception functions, for example, and not limited to, data encryption and data decryption, client-server authentication, channel security and data transmission integrity.

In the system, the cloud-based server infrastructure 120 includes a software stack stored in memory and operated by the processors of the cloud-based server infrastructure 120, which provides an Application Programming Interface (API) for the system 100 to utilize in communication and computing application control situations. For carrying out such communication and control with the cloud-based server infrastructure 120, the central server 110 includes an API control layer. In an embodiment, the API control layer is software based and includes code for instructions operable by the system 100 for communication with the APIs of the cloud-based server infrastructure 120.

### Process Flows

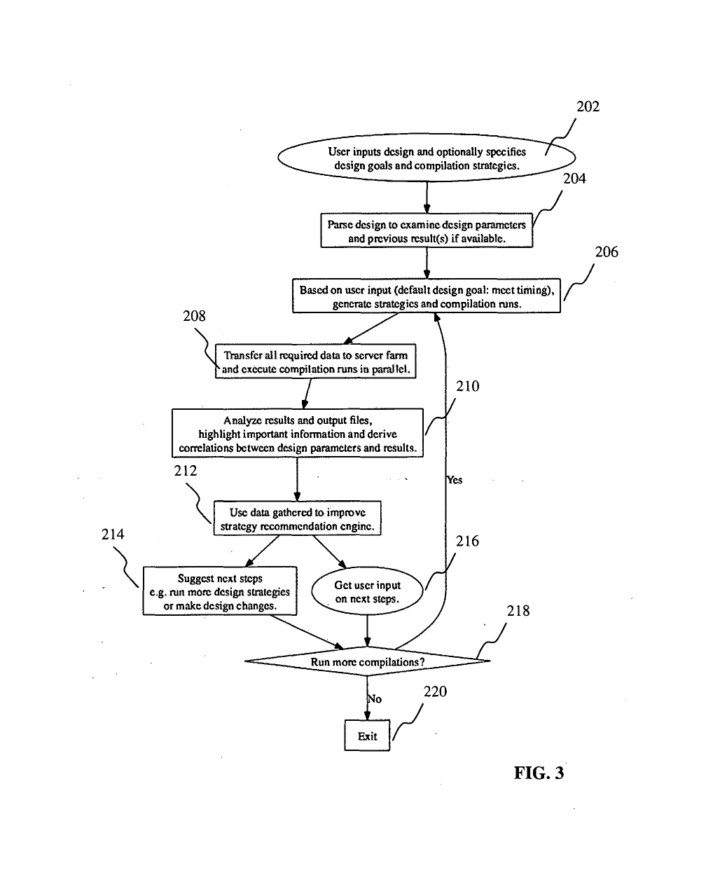

According to another aspect of the present disclosure, there is provided a method or process of designing an integrated circuit, more particularly, for compiling a design for an integrated circuit. FIG. 3 illustrates a flow diagram of a method 200 for designing an integrated circuit according to an aspect of the present disclosure. In a first method portion or block 202, a user submits an integrated circuit design, for example a field-programmable gate array (FPGA) design, to the system 100 of the present disclosure. According to the present embodiment, the integrated circuit design is submitted by the user through the web application 148 of the user's PC 102 for compilation of the design of the integrated circuit after the design has been generated by a design tool. Further, the web application 148 allows the user to configure or direct various tool options and/or design constraints in processing the circuit design into a format ready for manufacture or testing. Such tool options and/or design constraints can affect the end-result of a compilation process, each in its own way, leading to whether the integrated circuit design achieves its design objective(s). The web application 148 also allows a user to provide or input certain compilation strategies or selections on how the process of compilation should be carried out. In an embodiment, the compilation strategies vary the values of certain parameters accordingly, and in particular provide guidance to the present system 100 in determining or coming up with compilation sequences for the process of compiling the integrated circuit design.

As mentioned, the web application 148 is coupled to a client module 150 for secure communication with the central server 110 of the present system 100. According to the process, the submitted circuit design, together with user input or selections with regard to parameters and/or strategies are provided to the central server 110 through the client module 150, which initiates the communications path, encrypts the information for delivery, and transmits the necessary information to the central server 110, amongst other functions. The transmitted information is received at the central server 110 by the client-server communications module 152, which thereafter decrypts the received information for further processing by the computing system 112 of the central server 110.

In method block 204, the received circuit design is parsed to examine design parameters. This is carried out in the present embodiment by client module 150 and/or input analysis module 154 provided in the computing system 112. The input analysis module undertakes an initial analysis on the submitted circuit design and identifies parameters necessary for a compilation arrangement or run. As indicated above, integrated circuit design is a complex and somewhat laborious process, and there are a multitude of different options which can influence the output of the compilation process. As each integrated circuit is unique and carries with itself different design functionalities, limitations, and nuances, there is little or almost no certainty in how the options or parameters will affect the compilation run.

As part of the initial analysis carried out by the client module 150 and/or input analysis module 154, access is made to a database 156 of compilation results carried out or generated by or accessible to the system 100. The database 156 is provided via a partition of memory and/or data storage element(s) on the computing system 112 of the central server 110. The database 156 includes data from past compilation runs, and also includes information extracted from executed compilation outputs and analyzed for relationships and relevancies of parameters with respect to circuit designs. As part of initial analysis, the client module 150 and/or input analysis module 154 carries out a query based on the presently submitted new circuit design. For example, based on circuit design properties such as architecture type, process technology type, die size, number of stacks, etc., the client module 150 and/or input analysis module 154 searches through the database 156 in order to identify parameters which are of relevancy to the presently submitted circuit design. Relevancy may be defined in this case as parameters which are possibly correlated to an output efficiency in the compilation of a design.

In an embodiment, relevancy can be defined as a statistical weight in determining how a given parameter affects the efficiency of the circuit design. In other embodiments, heuristics and machine learning algorithms are also used to compute the relevancy.

In a next method block 206, strategies and compilation runs are built based on user input, with a default design goal of meeting timing constraints. If parameters relevant to the presently submitted circuit design can be identified by the input analysis module 154, such parameters are highlighted and passed along together with the circuit design and user input in relation to options and strategies for compilation to a compilation build module 158. Within the compilation build module 158, parameters pertinent to a compilation run of the circuit design are propagated, i.e. values of the parameters are propagated, such as to obtain a compilation sequence, to be ready for compilation of the circuit design. Propagation of the parameter values takes into account the relevancy, if any, of the parameters with respect to the presently submitted circuit design, and user-provided input options as well as strategies.

Method block 206 also seeks to provide or determine strategies as to attaining chip design goals. However, in describing a first iteration of the method of the present disclosure, possible strategies are rather limited and will usually describe obtaining as much and as varied of an experimental data as possible. Further description of providing strategies as according this method block will be discussed in more detail on further iteration of the present method.

Further, as mentioned, no one is truly certain how a newly presented circuit design will compile for the first time. For example, traditional FPGA design methodologies utilize adjusting a “placement seed” addressing the efficiency of their circuit designs. With placement seed adjustments, a user essentially is retrying the compilation in order to meet output efficiency, in particular timing constraints, without actually changing anything within the design. Placement seeds are typically automated with a place and route tool, which runs the implementation multiple times, each time with a variation on the seed position. As traditional compilations are run off a single seat license on a computing system, multiple iterations of the compilation have to take place consecutively, one after another. As such, placement seed adjustments conventionally need multiple iterations before patterns and relevancies can be identified, this leads to such a method requiring a very large amount of time in order to produce effective results.

A comparison of the system and method according to the present disclosure and presently carried out workflow is provided, simply for reference:

### Existing Workflow:

1. Create 1 compilation build with placement seed 1
2. Compile 1 build (or 2-3 simultaneously depending on available servers)
3. Manually analyze & compare each result with previous one(s) by examining log files generated by the chip design software.
4. Repeat with a different placement seed if the results do not attain desired values, spanning all seed values from 1 to 100.
5. Decide next step after all the seed values have been exhausted.

Workflow according to various embodiments of the present disclosure, with respect to a representative non-limiting number of compilation builds processed or considered together:

1. Create 100 “compilation builds” that differ in terms of placement seed
2. Compile all 100 builds in parallel
3. Analyze & compare all 100 results
4. Establish correlations between the 100 results
5. Decide next step in the time taken to compile 1 seed value

In the present embodiment, compilation runs can be operated in concurrence, with the provision of expandable cloud-based computing resources. Utilization of the placement seed with the present method allows the system to quickly undertake iterations for identification of patterns and/or relevancies. In this embodiment, up to 100 builds or compilation sequences are propagated by the compilation build module. Each build in itself is unique, for example, each build includes a different placement seed, over and on top of variations in historically identified relevant parameters. With available/sufficient computing resources to run the compilation sequences in parallel, the system 100 according to the present disclosure is able to quickly generate results of the compilations and generate or put together output results for analysis and relevancy extraction. The insight can allow the present system to iteratively provide additional input in compiling and optimizing the circuit design.

Additionally or alternatively, in providing an initializing set of compilation sequences for a new circuit design, the compilation build module 158 in some embodiments randomly picks certain parameters which will be present in a compilation run of the circuit design and propagates a random value for the picked parameter. Preferably, these picked parameters would be identified with a relevancy or a weightage in relation to output from the check made by the client module 150 and/or the input analysis module 154 on the database 156 of past results. Such a weightage is also taken into account in the random generation of values for the picked parameters. The aim of such a sequence is to obtain a set of experimental data, after carrying out the compilation, which would identify certain patterns or relevancies in relation to the plurality of parameters made available in compiling a circuit design, such that these parameters may be adjusted to provide for an optimized circuit design.

In method block 208, compilation builds or compilation sequences are transferred from the compilation build module 158 to a compilation execution module 160. The compilation execution module 160 is provided in the system 100, for compiling a received circuit design based on a plurality of compilation sequences with the computing resources available and determined by the computing resource management module 144.

In the present embodiment, the compilation execution module 160 determines the amount or number of computing resources needed for parallel or concurrent compiling of all of the plurality of compilation sequences and provides such an indication to the computing resource management module 144, which correlates the amount of computing resource presently available, and if possible, to requisition more computing resources from a local or third-party cloud computing service provider, in order to fulfill or attempt to best fulfill such a computing resource requirement request from the compilation execution module 160. In the event that the required computing resource exceeds the actual available resource, an indication is provided back to the compilation execution module 160 from the computing resource management module 144, which based on the available provided resource arranges for as many builds to be compiled concurrently, while placing the remainder builds in a queue for immediate consecutive compilation, after a computing resources become available or are freed up.

Further, in an embodiment, one of the received user inputs in the web application 148 is that of a preference of number of computing resource or server modules 116, 122 to be dedicated for the present compilation exercise. As a representative example, if there are 100 compilation runs and the user indicates via the web application 148 his preference for using only 50 servers, the system 100, in particular the compilation execution module 160, assigns 2 compilation runs per server. If the user does not state a preference, then each server is assigned a single compilation run, giving a total of 100 servers in the request provided to the computing resource management module 144.

Once computing resources have been determined and allocated, the compilation execution module 160 establishes a data connection between the module 160 and the assigned computing resource or server modules 116 or 122. Compilation information such as the circuit design, compilation builds or sequences and time and target for compilation execution, are provided by the compilation execution module 160 to the assigned computing resource and stored on a data storage element at the computing resource awaiting execution or instructions for execution if not already received. Execution is thereafter carried out by the computing resource carrying out compilation of the plurality of compilation builds in parallel, the main objective being to fully utilize each computing resource available to the system 100. It is of note that carrying out compilations in parallel translates to the system running each compilation as a separate process. This minimizes the occurrence of a failure of a compilation run in affecting subsequent compilation runs. Failures of compilation runs may be related back to the compilation execution module 160 for recording and for future extraction and on relevancy of parameters in contributing to compilation of an integrated circuit design as according to the present disclosure.

As mentioned above, server infrastructure 114, 122 includes or provides an API for the system 100 to utilize in communication and computing application control situations. In various embodiments the compilation execution module 160 includes an API control layer for such communication and control of server modules 116 and 122. It may be noted that server access module 142 and computing resource management module 144 also include such an API control layer.

As the compilation execution is carried out by the server module computing resources, the compilation execution module 160 carries out a monitoring sequence wherein information such as the type of compiler software tool used and the amount of time required or number of CPU hours consumed by each compilation run is recorded.

After compilation of all the compilation sequences are carried out, output files from the compilation are analyzed in association with method block 210. Particularly, the output files are analyzed to highlight important execution feedback information and to derive correlations between design parameters and compilation results. Upon completion of each of the scheduled compiler runs, the compiler software generates output files containing logs and results of the compilation. After completing all scheduled compiler runs, each server module thereafter sends output files for each compiler run executed back to the compilation execution module 160 for further analysis. The compilation execution module 160 receives or collates all the received output files, organizes them and appends on additional information recorded during the execution monitoring sequence onto specific compilation sequence output files. The compilation execution module 160 thereafter sends the complete set of output files onto a compilation analysis module 162 for further analysis.

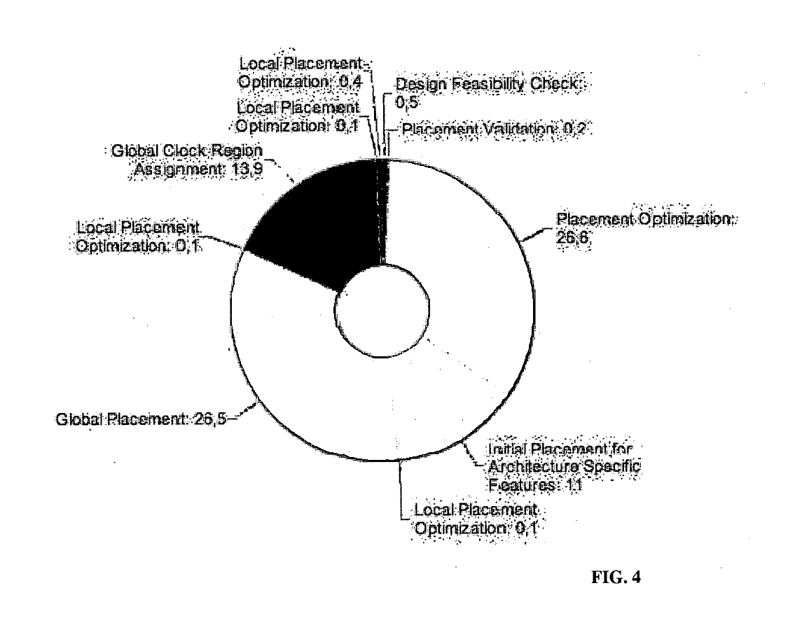

Within the compilation analysis module 162, the system 100 examines compilation outcomes by parsing files, and records values relevant to the user's design objectives. FIG. 4 illustrates design data which is extracted by the system according to an embodiment. In particular, compilation analysis module 162 charts or provides a breakdown of compiler execution time, and seeks to determine or understand which sub-processes utilized the most compiler time, e.g., in which sub-process the compiler spent the most time. In doing so, the end-user is able to determine which design changes or optimizations may impact or improve compilation timing the most.

Some representative sub-processes charted by the compilation analysis module 162 are indicated in FIG. 4. Sub-processes for which the compiler software spent the most time during compilation execution include Placement Optimization with 26.6% of time spent and Global Placement with 26.5% of time spent. A brief description of these sub-processes is provided as follows:

Placement optimization: The goal of which is to reduce the number of logical groups (and correspondingly, physical blocks) used in the final placement result.

Global placement: Placement in the FPGA context is the process of grouping and assigning logic elements in a design to the physical blocks in a gate array. Global placement typically refers to the first few passes where the FPGA chip is examined as a whole instead of as separate regions.

Further sub-processes included in the compiler software execution breakdown include, but are not limited to: initial placement for architecture specific features, global clock region assessment, local placement optimization, and design feasibility check.

As identified, the system 100 thereafter seeks to provide informed design change or optimization tweak suggestions based on the improving compilation time with respect to Placement Optimization and Global placement.

According to an embodiment, the compilation analysis module 162 carries out a highlighting of errors and flags out warnings during its review of the output files. The compilation analysis module 162 undertakes a review of compiler software output files, which provide logged feedback from the compiler software should certain issues or errors or warnings be raised. As an initial step, these errors or warnings are flagged and extracted for presentation to or consumption by the end user and provided on the web application user interface upon request. In particular, highlighting includes utilizing user interface elements such as colored text or shaded regions of text or diagrams.

Further, the compilation analysis module 162 compares, ranks and correlates design inputs and outputs from multiple iterations of the same circuit design, according to the method of the present embodiment. The compilation analysis module 162 identifies input variables such as the circuit design, the parameters pertinent to the design, constraints and compiler options and matches them with output results such as timing score, an area utilization and an estimated power, amongst others. Relationships between various input and output factors are sought and derived with the module 162, and machine learning techniques are also carried out on the output data in order to predict future outcomes, or in extracting relevancies and weightage scales for parameters with respect to output efficiency.

According to an embodiment, at least one machine learning algorithm such as a Support Vector Machine is used to find relationships or patterns between the input design parameters and the output behavior of the design after compilation. Such an algorithm outputs a range of possible outcomes and their corresponding probabilities of occurring. This is an iterative process where each set of inputs and outputs will be used as additional data to refine the machine learning algorithm(s). In other embodiments, additional or other machine learning methodologies or algorithms can include Unsupervised Clustering or Graphical Models.

Further, according to an embodiment, the compilation analysis module 162 compares, ranks and correlates design inputs and outputs from multiple iterations across different circuit designs, Database 156, stored on one or more data storage units or elements in or accessible to the central server 112, carries within compilation result information having been previously parsed and analyzed. The compilation analysis module 162 accesses the database 156 and matches together similar input or output variables or parameters, and/or carries out machine learning techniques, with the objective of obtaining sufficient correlation in order to determine relevancy of various variable inputs with respect to differing circuit diagram designs. It is also note that every compilation result is recorded in the database 156, along with values like the placement seed, computed circuit area, computed circuit power, computed circuit clock frequency, and even FPGA type. As a representative example pertaining to placement seeds, if an engineer or a designer submits a similar circuit design in the future, cross-reference can be carried out by the analysis module 162 or the optimization module. Further as an example, placement seeds that produced poor results for this present compilation will be suggested or selected at lower priorities with respect to future compilations.

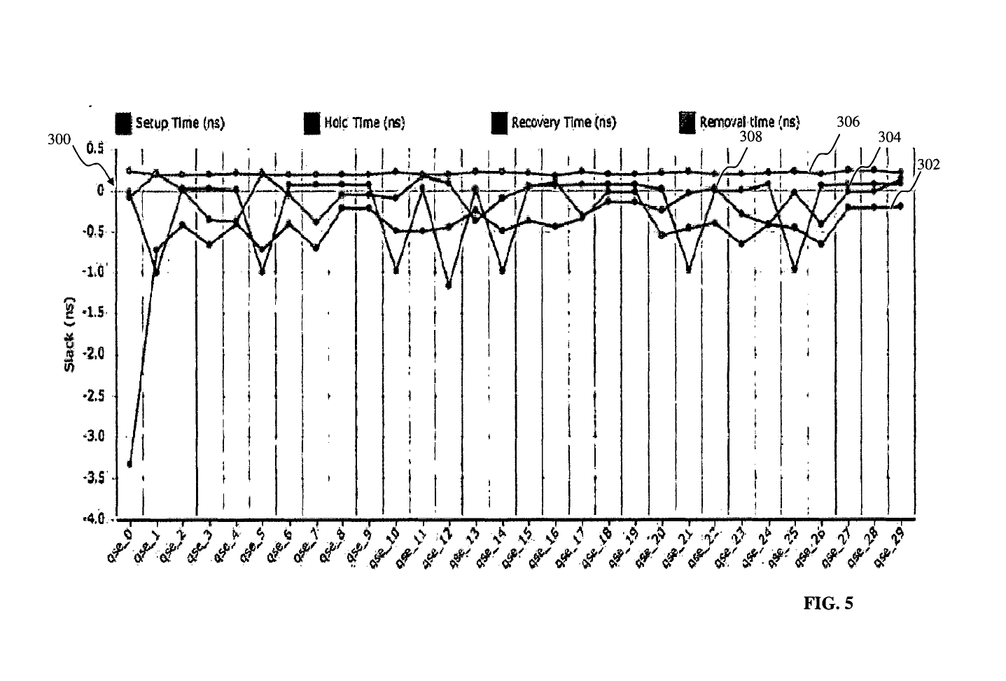

FIG. 5 illustrates a representative resultant compilation output timing chart after carrying out a set of compilation runs according to the present embodiment. The chart 300 plots timing results (y-axis) against multiple compilation runs (x-axis). Further, the compilation time has been broken down into timing factors—setup time 302, hold time 304, recovery time 306 and removal time 308, to provide better resolution with regard to the compilation timing outputs and for quick identification of compilation runs which are more likely to meet design objectives.

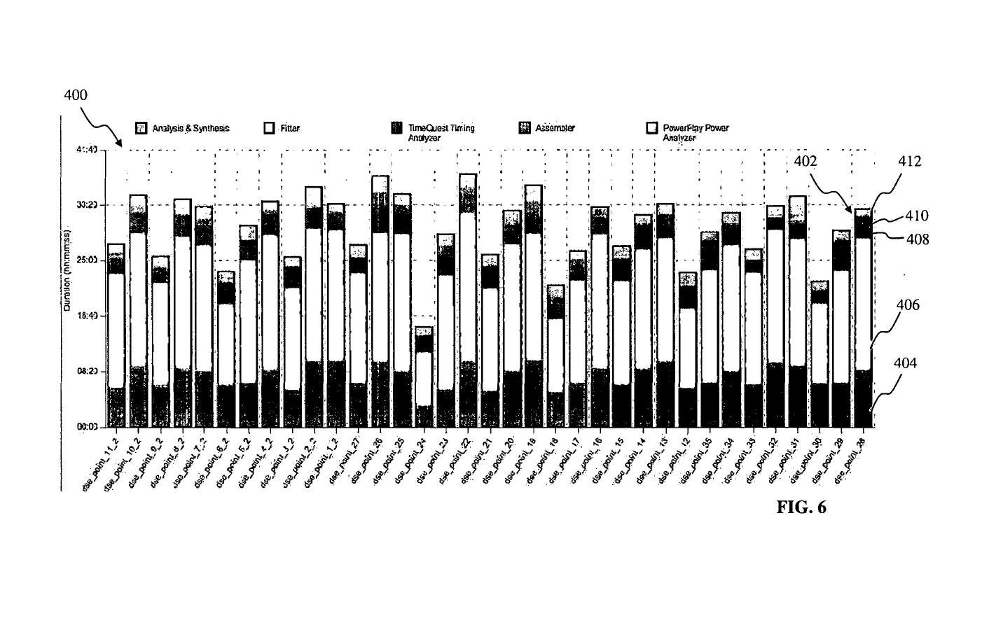

FIG. 6 illustrates a resultant compilation output software runtime chart after carrying out compilation runs according to the present embodiment. The chart 400 plots software runtime (y-axis) against multiple compilation runs (x-axis). Further, the software runtime block 402 for each compilation run is broken down into compilation steps—analysis and synthesis 404, filter 406, timing analysis 408, assembly 410, and power analysis 412, which similarly allow for quick identification of compilation runs which are more likely to meet design objectives.

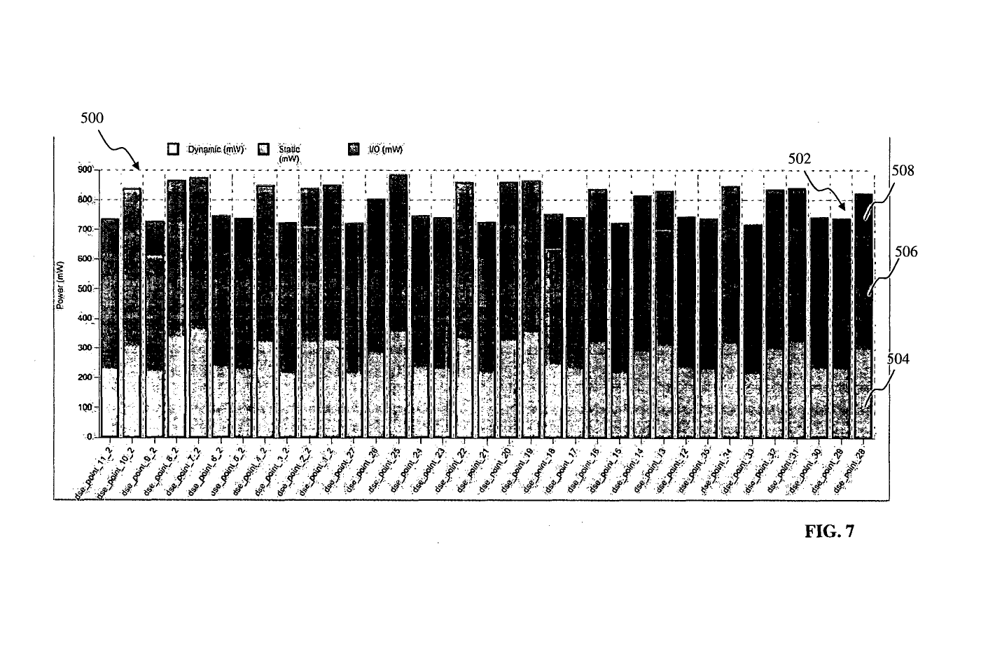

FIG. 7 illustrates a resultant compilation output power estimate chart after carrying out compilation runs according to the present embodiment. The chart 500 plots power estimates (y-axis) against multiple compilation runs (y-axis). Further, the power efficiency block 502 for each compilation run is broken down into particular power estimate types—dynamic power 504, static power 506, and input/output 508, which similarly allow for quick identification of compilation runs which are more likely to meet design objectives.

In method block 212, the data gathered is used to improve strategy recommendation. In carrying out the above described analysis, the compilation analysis module 162 creates and preferably is able to derive relevancies of various options or parameters to the compilation sequence. Such information is passed to an optimization module 164, which supervises strategy suggestions and implementations. In a method block 214, the method further provides suggestions for the next steps of the circuit design process, in particular the compilation of the circuit design and obtaining satisfactory compilation results therefrom, with the optimization module 164. Based on at least the possible outcomes and probabilities with respect to the individual compilation run, the present system and method seeks to address and generate suggestions for improving the presently run compiler run sequences. An example of a next step in a compilation sequence is to have the user to run more design strategies or to make changes to the integrated circuit design.

In method block 216, these suggestions are relayed back to the user and the system 100 awaits user input for the next steps of the circuit design optimization. In particular, once post-compilation analysis is carried out by the compilation analysis module 162, the information for the user, for example—a summary of the compilation results, warnings, errors, summary of post-compilation analysis, suggestions, and relevancy of parameters, is packaged and subsequently relayed to the client-server communication module 152 for transmission back to the user, through the client module 150 and web application 148.

In method block 218, the user decides whether or not to run additional sets of compilations, based on the information provided by the system 100, in particular to the most recent sets of compilation output data, parsed and extracted for easy viewing by the user. For example, after carrying out a first round of compilation iterations, a user reviews the incoming compilation output data. Having noticed that design objectives have yet to be met, and the circuit design has not yet completed compilation, a user could thus provide instructions as to running a second round of compilation iterations.

In method block 220, the method determines if more compilations are required by referring to the user's provided input in method block 218. If the user has decided that the compilation runs carried out are sufficient and the design objectives are met or sufficiently satisfied, he may conclude that no further compilation runs are necessary and that the design is compiled and completed. The method block 220 provides a conclusion to the compilation exercise with respect to the provided input circuit design.

However, if additional compilation runs are required, method blocks 206 to 216 are repeated again to obtain further results in compiling the provided circuit design. Such an iterative process allows for refining as with each run, more experimental data for correlation is obtained, thereby refining derivations and projections as to how various parameters or options affect the resultant compilation of the circuit design in achieving predetermined design objectives.

After obtaining compilation output results after a first iteration of the method flow diagram, there may be sufficient information available to properly provide various strategies in optimizing the chip design for compilation according to the present system in achieving chip design goals. Within method block 206, the optimization module 164 creates compilation strategies based on the above described analysis carried out by compilation analysis module 162. Each strategy includes design parameters such as modeling parameters, design constraints and compiler software options.

Further, if the user has specific ideas or selections on one or more elements of the design strategies, the user can input such ideas or selections. The system takes such user input into consideration and adjusts the design strategies accordingly, for example, to omit certain compiler options. As mentioned above, user input into the system can be provided through web application 148. The appended table below shows various examples of generated design strategies:

TABLE 1

| | | MUX_ | ALLOW_ | |
|---|---|---|---|---|
| | | RE- | POWER_ | PLACEMENT_ |
| Compilation | | STRUC- | UP_DONT_ | EFFORT_ |
| run | SEED[1] | TURE | CARE | MULTIPLIER |
| strategy_1000 | 100 | Auto | On | 4.5 |
| strategy_100 | 15 | Auto | On | 3 |
| strategy_101 | 35 | Auto | Off | 1 |
| strategy_102 | 1 | Auto | On | 1.5 |
| strategy_103 | 70 | Off | On | 2.5 |
| strategy_104 | 40 | Auto | Off | 2.5 |
| strategy_105 | 85 | Off | Off | 1 |
| strategy_106 | 45 | Auto | Off | 4 |
| strategy_107 | 95 | On | On | 5 |
| strategy_108 | 20 | Auto | Off | 3.5 |
| strategy_109 | 95 | On | Off | 2 |
| strategy_10 | 25 | Auto | On | 5 |
| strategy_110 | 50 | On | Off | 4.5 |
| strategy_111 | 60 | Auto | Off | 1.5 |
| strategy_112 | 35 | Off | Off | 3.5 |
| strategy_113 | 5 | On | Off | 3 |
| strategy_114 | 55 | On | On | 1.5 |
| strategy_115 | 70 | On | Off | 2.5 |
| strategy_116 | 35 | On | On | 3.5 |
| strategy_117 | 40 | Off | On | 2 |

The first column lists compilation runs and the remaining columns contain either design parameters or outputs. When any particular design parameter or any combination of design parameters is detected to influence an output value by a specific percentage across all compilation runs, the parameter or combination of parameters is assigned a corresponding weight. These weights are used in generating strategies for subsequent compilation runs.

Each row represents a particular strategy and each column apart from the first is an input parameter whose value can be varied for improvement. The system assigns probabilities to each parameter and to combinations of parameters. The probabilities are derived from aggregation of past design results (e.g., where such probabilities are learned via machine learning algorithms).

The system then generates different permutations of these input parameters based on these probabilities.

In another embodiment of the system according to the present disclosure, there is no central server provided for central control and distribution of the tasks. Two pertinent hardware modules remain—the user's PC 102 and the cloud-based server infrastructure 120. In such a case, described features pertaining to the central server of the earlier embodiment are shifted instead to the cloud-based server infrastructure 120. Operation of a cloud-based computing system to carry out the functions of the earlier described central server may be considered equitable and no function is affected. The advantage of such an embodiment is that there is no need to host a physical server infrastructure. Instead, one can fully rely on a cloud-computing based system.

It is thus noted that one of the main tasks of the system according to this embodiment is carried out by the computing resource management module, which keeps track of which computing resources are available and provisions for a scalable demand of additional cloud computing resources are submitted as soon as understood from the compilation execution module.

Aspects of particular embodiments of the present disclosure address at least one aspect, problem, limitation, and/or disadvantage associated with existing integrated circuit design systems. While features, aspects, and/or advantages associated with certain embodiments have been described in the disclosure, other embodiments may also exhibit such features, aspects, and/or advantages, and not all embodiments need necessarily exhibit such features, aspects, and/or advantages to fall within the scope of the disclosure. It will be appreciated by a person of ordinary skill in the art that several of the above-disclosed systems, components, processes, or alternatives thereof, may be desirably combined into other different systems, components, processes, and/or applications. In addition, various modifications, alterations, and/or improvements may be made to various embodiments that are disclosed by a person of ordinary skill in the art within the scope and spirit of the present disclosure. Such different systems, components, processes and/or modifications, alterations, and/or improvements are encompassed by the following claims.

1: A method for designing an integrated circuit, comprising:
accessing a circuit design and identifying a plurality of parameters related to an achieved efficiency of the circuit design;
propagating values into the plurality of parameters to obtain a compilation sequence for compiling the circuit design, further comprising obtaining a plurality of compilation sequences;
providing the circuit design and the plurality of compilation sequences as input to a compilation execution module for compiling the circuit design based on the plurality of compilation sequences on an array of computing modules;
obtaining an output score for each of the plurality of compiled compilation sequences in validating the integrated circuit design; and
identifying the occurrence of output scores meeting a predetermined performance target, and if none, propagating values into the plurality of parameters to obtain a further plurality of compilation sequences for compiling at the compilation execution module;
wherein the compiling of the plurality of compilation sequences is carried out in parallel

2: The method according to claim 1, further comprising:
collating the output score together with the compilation sequence input for each of the plurality of compiled compilation sequences for storing in a database; and
correlating output scores with the values of the plurality of parameters for each of the plurality of the compiled compilation sequences in determining a relevancy for each of the plurality of parameters in relation to the achieved efficiency.

3: The method according to claim 2, further comprising utilizing the relevancy for each of the plurality of parameters in propagating values into the plurality of parameters to obtain a further plurality of compilation sequences for compiling at the compilation execution module.

4: The method according to claim 3, wherein the parameters with a higher relevancy are propagated first in obtaining a compilation sequence.

5: (canceled)

6: The method according to claim 4, wherein the relevancy is determined by any one of a statistical weight, heuristics, and a machine learning algorithm.

7: The method according to claim 2, further comprising analyzing compiler output files for a compiled compilation sequence, and identifying any one of: compilation timings for a plurality of sub-processes during compiling, timing results factors, software runtime for compilation steps, and power estimate types.

8: The method according to claim 7, wherein the compilation timings are correlated to determine a sub-process for which design changes have statistically the greatest effect on the compilation timings.

9: The method according to claim 8, wherein the sub-process comprises at least one of: initial placement for architecture specific features, global placement, placement optimization, global clock region assessment, local placement optimization, and design feasibility check.

10: The method according to claim 1, wherein propagating values into the plurality of parameters to obtain a compilation sequence for compiling of the circuit design further comprises:
accessing a database and, based on the circuit design, determining a relevancy for each of the plurality of parameters in relation the achieved efficiency; and
utilizing the relevancy for each of the plurality of parameters in propagating values into the plurality of parameters to obtain a compilation sequence.

11: (canceled)

12: The method according to claim 1, further comprising determining the computing resource to be used and committing the computing resource in compiling the circuit design based on the plurality of compilation sequences.

13-21: (canceled)

22: A system for designing an integrated circuit, comprising:
an input analysis module for accessing a circuit design and identifying a plurality of parameters related to an achieved efficiency of the circuit design;
a compilation build module for propagating values into the plurality of parameters to obtain a compilation sequence for compiling the circuit design, further for obtaining a plurality of compilation sequences;
a compilation execution module for:
receiving the providing the circuit design and the plurality of compilation sequences;
compiling the circuit design based on the plurality of compilation sequences on an array of computing modules; and
obtaining an output score for each of the plurality of compiled compilation sequences in validating the integrated circuit design; and
a compilation analysis module for identifying the occurrence of output scores meeting a predetermined performance target, and if none, instructing the compilation build module to propagate values into the plurality of parameters to obtain a further plurality of compilation sequences for compiling at the compilation execution module;
wherein the compiling of the plurality of compilation sequences is carried out in parallel.

23: The system according to claim 22, wherein the compilation analysis module is further for:
collating the output score together with the compilation sequence input for each of the plurality of compiled compilation sequences for storing in a database; and
correlating output scores with the values of the plurality of parameters for each of the plurality of the compiled compilation sequences in determining a relevancy for each of the plurality of parameters in relation to the achieved efficiency.

24: The system according to claim 23, wherein the compilation build module further utilizes the relevancy for each of the plurality of parameters in propagating values into the plurality of parameters to obtain a further plurality of compilation sequences for compiling at the compilation execution module.

25: The system according to claim 24, wherein the parameters with a higher relevancy are propagated first in obtaining a compilation sequence.

26: (canceled)

27: The system according to claim 25, wherein the relevancy is determined by any one of a statistical weight, heuristics, and a machine learning algorithm.

28: The system according to claim 23, wherein the compilation analysis module is further for analyzing compiler output files for a compiled compilation sequence, and identifying any one of: compilation timings for a plurality of sub-processes during compiling, timing results factors, software runtime for compilation steps, and power estimate types.

29: The system according to claim 28, wherein the compilation timings are correlated to determine a sub-process for which design changes have statistically the greatest effect on the compilation timings.

30: The system according to claim 28, wherein the sub-process includes at least one of: initial placement for architecture specific features, global placement, placement optimization, global clock region assessment, local placement optimization, and design feasibility check.

31: The system according to claim 22, wherein the compilation analysis module is further for:
accessing a database and, based on the circuit design, determining a relevancy for each of the plurality of parameters in relation the achieved efficiency; and utilizing the relevancy for each of the plurality of parameters in propagating values into the plurality of parameters to obtain a compilation sequence

32: (canceled)

33: The system according to claim 22, further comprising a computing resource management module for determining the computing resource to be used and committing the computing resource in compiling the circuit design based on the plurality of compilation sequences.

34-42: (canceled)
